(19) United States
(12) Patent Application Publication
(10) Pub. No.: US 2008/0139195 A1
(43) Pub. Date: Jun. 12, 2008

(54) Remote access for mobile devices

(76) Inventors: David John Marsyla, Belmont, CA (US); Faraz Ali Syed, Dublin, CA (US)

Correspondence Address: MORRISON & FOERSTER, LLP, 555 WEST FIFTH STREET, SUITE 3500, LOS ANGELES, CA, 90013-1024, US

(21) Appl. No.: 11/636,062

(22) Filed: Dec. 7, 2006

(51) Int. Cl. H04Q 7/20

(52) U.S. Cl. 455/423

(57) ABSTRACT

Remote testing of a Mobile Device or Mobile Application while that device is located in a target Carrier Network is disclosed. A person, or an automated program, running the test remotely (“Remote Tester”) or (“Remote Automation Script”), does not need to be present in the target Carrier Network, and can control all functions of the Mobile Device over a standard computer network, or the Internet. The functions of the Mobile Device are controlled by interacting with a local application (“Device Conductor”) which communicates with a server managing the remote device (“Device Server”) using standard Internet communication protocols. The Device Server will pass all commands to a hardware or software based controller (“Device Controller”) which will directly operate the Mobile Device in a manner similar to how the device would be operated by a person that is located near the device.

### FIELD OF THE INVENTION

This invention relates to computerized test systems, and more specifically, to a method and apparatus of remotely accessing, with the intent of testing, mobile information processing devices, or the applications designed for these devices, while the device resides in a remote wireless carrier network.

### BACKGROUND OF THE INVENTION

A number of mobile information processing devices (“Mobile Devices”) are produced each year, with the intent of deploying the devices in wireless carrier networks (“Carrier Networks”) located around the world.

Mobile Devices include wireless phones, wireless PDA's, and other devices that require a Carrier Network to be fully operational. Carrier Networks include, but are not limited to GSM, GPRS, CDMA, WCDMA, EDGE and other 3G wireless networks.

The growing capabilities of Mobile Devices have led to a rapid expansion in the number of software applications such as mobile games and mobile internet content being developed for these devices. It has also led to a proliferation of downloadable background images or “wallpaper”, and musical songs played during an incoming call or “ringtones”. Together these applications and downloadable files are referred to as mobile applications (“Mobile Applications”).

Due to the variety of Mobile Devices available, and the variety of Carrier Networks in common use, it is necessary for Mobile Application developers to test their applications for compatibility on a large number of mobile handsets, and in several Carrier Networks.

Previously, the majority of this testing was performed by purchasing a copy of each target Mobile Device, traveling to the Carrier Network where and application was to be deployed, and manually testing the Mobile Content on each device. For an increasing number of Mobile Applications, it is necessary to deploy and test the application on a Mobile Device that is physically located in a Carrier Network where the application is to be used. This is necessary due to complex interactions of the Mobile Applications with the network infrastructure provided by the Carrier Network.

This manual Mobile Device and Carrier Network compatibility testing has become one of the most expensive and time consuming activities related to Mobile Application development, often representing 20-30% of the budget for application development. Hence there is a need for test systems which can be used to simplify or automate the testing process for this Mobile Content, and reduce the need to travel to each Carrier Network.

Due to the globally diverse locations of these Carrier Networks, this manual testing approach it is often impractical due to the cost and time necessary to travel to the necessary locations to perform the tests.

Other previous approaches have involved the use of network emulation technology, to simulate the Carrier Network in a local testing lab. An example of this emulation technology would be a wireless network hardware signal generator which can generate a variety of Carrier Network protocol signals, and provide a simple internet connection for a Mobile Device. This approach is often insufficient for a complete validation of a Mobile Application, in that it can only partially re-produce the network infrastructure of an actual Carrier Network. This limitation occurs because modern wireless Carrier Networks contain much more than just signal towers. Carrier Networks contain various internal systems such as wireless internet portals, application download servers, billing processing servers, networked application environments such as multi-player game portals, streaming video servers, and dozens of other systems. Although network signal generators can emulate a simple connection to the internet, they cannot emulate the specialized systems needed for Mobile Application development and testing.

Therefore, there is a need to be able to test Mobile Applications on a variety of Mobile Devices without having to be physically present in the target Carrier Network, in a manner that is low cost and capable of fully reproducing the network infrastructure of an actual carrier network.

### SUMMARY OF THE INVENTION

The present invention provides a means for remotely testing a Mobile Device or Mobile Application while that device is located in a target Carrier Network. A person, or an automated program, running the test remotely (“Remote Tester”) or (“Remote Automation Script”), does not need to be present in the target Carrier Network, and can control all functions of the Mobile Device over a standard computer network, or the Internet. The functions of the Mobile Device can be controlled by interacting with a local application (“Device Conductor”) which communicates with a server managing the remote device (“Device Server”) using standard Internet communication protocols. The Device Server can pass commands to a hardware or software based controller (“Device Controller”) which can directly operate the Mobile Device in a manner similar to how the device would be operated by a person that is located near the device.

The Device Server and Device Controller together can have several functions. One function of is to accept incoming commands from the Remote Tester or Remote Automation Script to control all functions of the Mobile Device. Another function is to communicate all outgoing information, including video, audio, and other visual and tactile responses from the Mobile Device back to the Remote Tester or Remote Automation Script.

Although in some embodiments the Device Server uses a general purpose computer, it is also possible to use a custom designed processing unit, based on any type of readily available CPUs, or based on a proprietary designed logic circuit such as an FPGA or CPLD, or any other type of programmable logic circuit. In this alternate configuration, the Device Controller may be more closely integrated with the Device Server into a single hardware platform, but the functionality of the two components will not change significantly.

### BRIEF DESCRIPTION OF THE DRAWINGS

FIG. 1 is a block diagram of an exemplary system environment according to some embodiments of this invention.

FIG. 2 is a block diagram of an exemplary Device Picture on a Device Conductor according to some embodiments of this invention.

FIG. 3 is a block diagram of an exemplary Device Conductor according to some embodiments of this invention.

FIG. 4 is a block diagram of an exemplary Device Server according to some embodiments of this invention.

FIG. 5 is a block diagram of an exemplary Device Controller and Mobile Device according to some embodiments of this invention.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

Embodiments of the present invention are directed to remotely testing a Mobile Device or Mobile Application while that device is located in a target Carrier Network. A person, or an automated program, running the test remotely (“Remote Tester”) or (“Remote Automation Script”), does not need to be present in the target Carrier Network, and can control all functions of the Mobile Device over a standard computer network, or the Internet. The functions of the Mobile Device can be controlled by interacting with a local application (“Device Conductor”) which communicates with a server managing the remote device (“Device Server”) using standard Internet communication protocols. The Device Server can pass commands to a hardware or software based controller (“Device Controller”) which can directly operate the Mobile Device in a manner similar to how the device would be operated by a person that is located near the device.

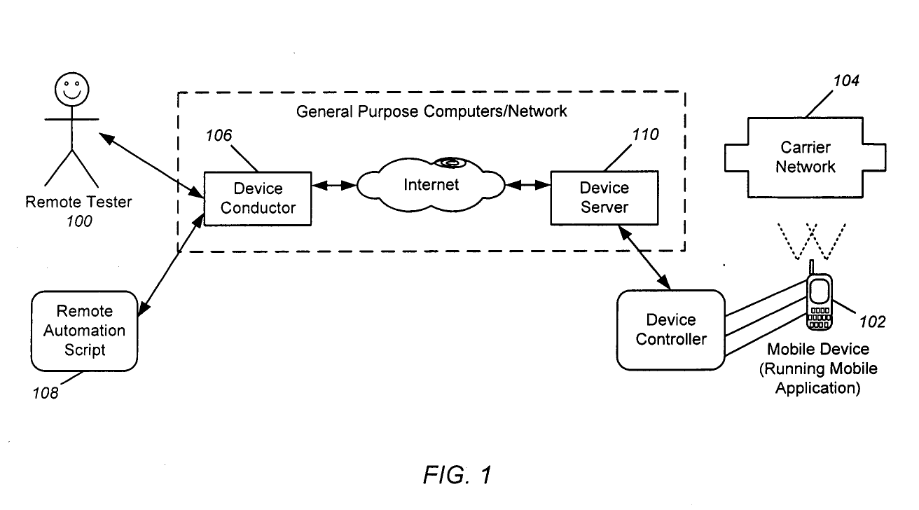

FIG. 1 is a block diagram of an exemplary system environment according to some embodiments of this invention. The Remote Tester 100 may be a person who is testing a Mobile Application that requires a Mobile Device 102 to reside in a particular Carrier Network 104. The Remote Tester 100 may control one or more Mobile Devices 102 that reside in the Carrier Network 104 and view their visual, audio and tactile output, as if the Remote Tester were physically located near the device. The Remote Tester 100 can interact with the Device Conductor software application 106 in order to control one or more Mobile Devices 102.

The Remote Automation Script 108 is a software program that can be written in any common programming language that is designed to test a Mobile Application that requires a Mobile Device 102 to reside in a particular remote Carrier Network 104. The Remote Automation Script 108 can act on behalf of a Remote Tester 100 who would like to control one or more Mobile Devices 102 that reside in the Carrier Network 104 and view their visual, audio and tactile output,.as if the person were physically located near the device.

The Remote Automation Script 108 may run in an unattended mode, or may be observed by a Remote Tester 100, and can perform all of the same interactions with the Device Conductor software application 106 that a person could perform.

### Device Conductor

The Device Conductor 106 is a software application that runs on a general purpose computer and can be operated by a person (e.g. Remote Tester 100), or automated testing application (Remote Automation Script 108). The Remote Tester 100 or Remote Automation Script 108 can use the application to control one or more Mobile Devices 102 that physically reside in a remote Carrier Network 104.

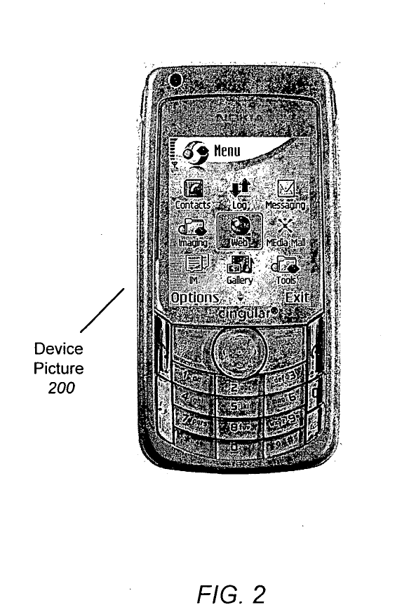

FIG. 2 is a block diagram of an exemplary Device Picture on a Device Conductor according to some embodiments of this invention. The Device Conductor can have a number of primary roles in the system. One role is to provide a graphical user interface for the Remote Tester, and to convert the actions performed by the Remote Tester into Network Messages bound for the Device Server. The user interface for interacting with the Mobile Device can be displayed as a graphical photograph of an actual device (the Device Picture 200) which can be sensitive to standard input devices found on a general purpose computer. The Device Picture 200 could also be displayed as a hand drawn, or computer generated image or any other graphical layout that provides a representative image of the Mobile Device.

Another role is to provide a software programming API (“Device Conductor API”) for the Remote Automation Script, and to convert the actions performed by the script into Network Messages bound for the Internet. This Device Conductor API is typically an interface module for a standard programming language such as Java, C++, or Perl, but can also be a visual scripting interface whose instructions are represented by graphical icons, or a mix of icons and textual information.

Yet another role is to receive Network Messages from the Internet that represent video, audio or other feedback from the Mobile Device. If the operator of the application is a person, the feedback can be displayed in a UI format similar to what the person would see if the Mobile Device were available locally. If the operator is a Remote Automation Script, the feedback can be used to provide automated comparisons against pre-defined events in order to perform an automated test of a Mobile Application.

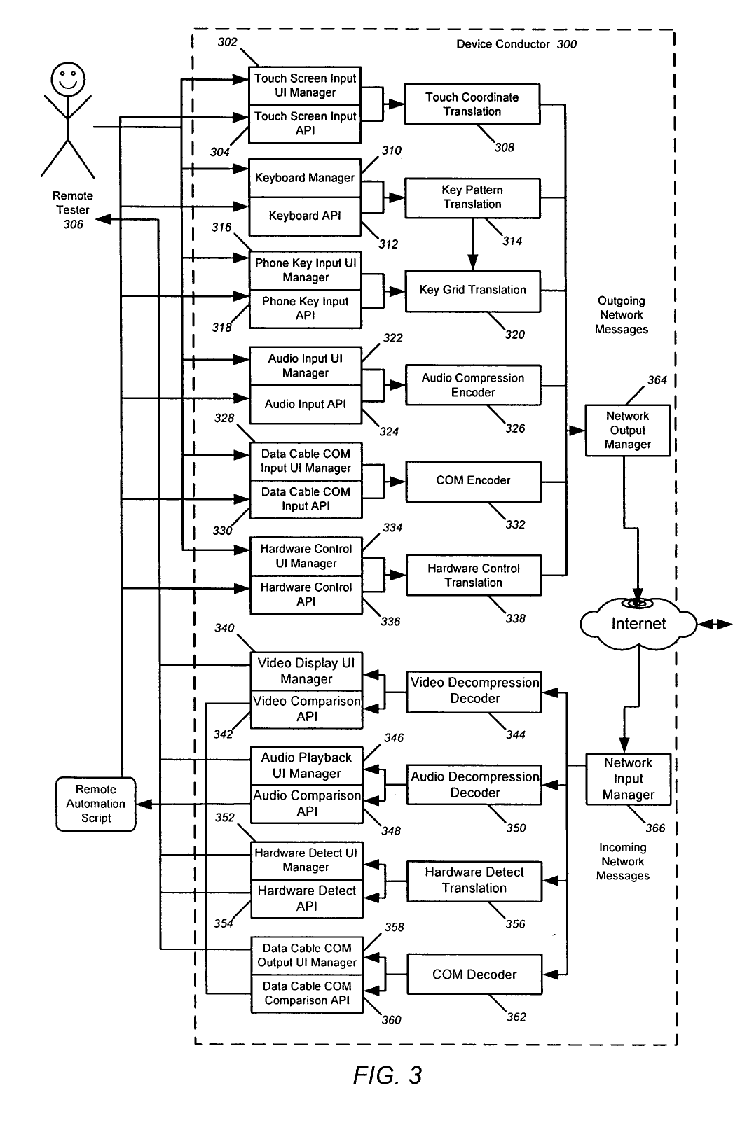

FIG. 3 is a block diagram of an exemplary Device Conductor 300 according to some embodiments of this invention. If the Mobile Device supports a touch screen input device (generally a touch sensitive panel over the device display), the Touch Screen Input UI manager 302 in the Device Conductor 300 can allow the Remote Tester 306 to click on the Device Picture in order to cause the touch screen on the actual Mobile Device to be pressed as if by a person at that remote location. The touch screen can be pressed by pressing a region of the Device Picture using a pointing device such as a mouse, touch pad, or touch sensitive display connected to the local computer. The visual representation of the touch screen may be a graphical image of the screen, a pre-defined visual region, or any other common form of input selection provided by standard graphical user interfaces. The touch screen can be pressed by pressing on a representative key of the computer keyboard. The representative key of the computer keyboard may match a corresponding pressure location on the Mobile Device, or may be mapped to any key on the keyboard that is convenient to use for a particular application.

If the Mobile Device supports a touch screen input, the Device Conductor API can support a method to allow the Remote Automation Script to cause the touch screen on the actual Mobile Device to be pressed as if by a person at that remote location. The Device Conductor allows the Remote Automation Script to call a Touch Screen Input API 304 to select an X,Y coordinate of the touch screen on the actual Mobile Device to be pressed as if pressed by a person at that remote location.

The Touch Screen Coordinate Translation process 308 can then convert the X, Y touch screen input location selected by the UI or the API into a range of values that are more suitable for the particular touch screen available on the Mobile Device. This translation may be necessary because the range of possible touch sensitive positions on a Mobile Device display is often different than the range of locations that can be selected in the user interface of a standard desktop computer. The translation can be a simple scaling of the X, Y coordinates to better match the input range of the Mobile Device. The translation may also include shifting of values in the positive or negative direction and non-linear scaling of the value ranges.

The Keyboard Manager 310 in the Device Conductor 300 allows alphabetic, numeric and symbolic keys to be pressed by the Remote Tester 306 on a standard desktop computer keyboard and can translate those keyboard presses into key pad presses on the Mobile Device. Since the typical computer keyboard contains a wider variety of keys than a typical Mobile Device, some characters or symbols will not be supported, and others will require a translation in order to find the closest match available on the Mobile Device.

The Keyboard API 312 supports a method for the Remote Automation script to select keyboard keys as if those keys were being pressed by the Remote Tester. Keys can be pressed in a delayed manner by first defining an instruction for pressing one or more keys, and then causing a process to initiate at a later time which will execute the instruction and will press one or more keys in a sequence as if they were being pressed by the Remote Tester.

Since the typical computer keyboard contains a wider variety of keys than a typical Mobile Device, some characters or symbols will not be supported, and others will require a translation in order to find the closest match available on the Mobile Device. Generally, several translation mappings are required for a typical Mobile Device to support the various key pad input modes supported by the device. For example, in some modes, pressing the 2 key on a Mobile Device will act as if the number 2 has been pressed, and in other modes the same key will act as if the letter A has been pressed. Many Mobile Devices require multiple key presses to represent alphabetic or symbolic characters to be input to the device. For example, the letter C is commonly represented by pressing the 2 key three times.

The Key Pattern Translation step 314 will determine the correct physical key sequence that is necessary to represent a particular keyboard input character on the display of the Mobile Device. The specific translation modes and key sequences for a particular device is generally determined ahead of time and stored in a central database or other persistent storage location. After this step, it is also necessary to perform the Key Grid Translation before sending the key request to the Mobile Device.

With regard to the Phone Key Input UI Manager 316, the Device Conductor allows the Remote Tester to click on the Device Picture in order to cause the keys on the actual Mobile Device to be pressed as if by a person at that remote location. The Device Picture will generally contain graphical regions which represent the location of the actual keys on the Mobile Device. A separate layout mapping, or screen location lookup, can be used to map the user's input to the key to be pressed. Keys can be pressed by pressing a visual representation of the Mobile Device key using a pointing device such as a mouse, touch pad, or touch sensitive display. The visual representation of the key may be a graphical image of the key, a pre-defined visual button, a drop down menu item, or any other common form of event selection provided by standard graphical user interfaces.

The Phone Key Input API 318 supports a method for the Remote Automation Script to press a key on the Mobile Device as if those keys were being pressed by the Remote Tester. Keys can be pressed in a delayed manner by first defining an instruction for pressing one or more keys, and then causing a process to initiate at a later time which will execute the instruction and will press one or more keys in a sequence as if they were being pressed by the Remote Tester.

With regard to Key Grid Translation block 320, Mobile Devices generally contain multiple hardware contacts for each key that can be pressed on the device. The keys are commonly laid out in a grid pattern whereby selecting an X and Y location on the grid will select a particular key that is found at the intersection of the grid locations. Although the actual grid varies by device model, a translation from the physical key to the grid is generally needed. The layout of the grid is generally determined ahead of time and stored in a central database or other persistent storage location.

The Audio Input UI Manager 322 allows the Remote Tester to speak into a local microphone, or play a pre-recorded sound and send that audio data to the remote Mobile Device, causing audio information to be communicated to the device as if spoken or played from recording by a person at that remote location. Audio data communicated to the Mobile Device may be played at the same volume as audio information would be spoken or played from recording. Audio data communicated to the Mobile Device may be played at a louder or softer volume than the original audio would be spoken or played from recording. Audio data may be sampled from a microphone, connected headset, or any other commonly used method of recording audio data on a computer. This may be done in conjunction with volume changes. Audio data on the local computer may be sampled at various rates in order to increase or decrease the level of audio quality communicated to the remote Mobile Device.

The Audio Input API 324 supports a method for the Remote Automation Script to play a pre-recorded sound and send that audio data to the remote Mobile Device, causing audio information to be communicated to the device as if spoken or played from recording by a person at that remote location. Audio data communicated to the Mobile Device may be played at the same volume as audio information would be spoken or played from recording. Audio data communicated to the Mobile Device may be played at a-louder or softer volume than the original audio would be spoken or played from recording. Audio data may be sampled from a microphone, connected headset, or any other commonly used method of recording audio data on a computer. This may be done in conjunction with volume changes. Audio data on the local computer may be sampled at various rates in order to increase or decrease the level of audio quality communicated to the remote Mobile Device.

With regard to the Audio Compression Encoder block 326, the Device Conductor will encode and compress the audio data into a lower bandwidth format which represents as closely as possible the original audio information that was input to Device Conductor. One method of encoding the audio is to filter out any audio below a particular noise threshold since that audio may not be audible by the remote Mobile Device. After filtering the low volume audio information, an encoder suitable for both music and voice, such as an MP3 encoded audio format is used to reduce the size of the audio information to be transferred.

The actual method and format of encoding the audio data is generally not important as long as the audio information can be reconstructed later to represent something that would be perceived as similar to the original audio information. Several standard and proprietary encoding formats will work equally well for reducing the amount of audio information that is to be sent over the Internet. It is also equally valid to transfer the audio data in an uncompressed format, but this is less desirable due to the amount of network bandwidth consumed by this information.

Many Mobile Devices support some type of data cable to connect the device to a common desktop computer. This Data Cable may be a USB (Universal Serial Bus) cable, or a Serial (RS-232) cable, or some type of wireless connection such as Bluetooth. This data cable is generally used to communicate with the operating system of the mobile device, and is often used to issue commands, such as dialing instructions, or to receive status information about the device. It can also be used to transfer data files, address book information, or application files to the Mobile Device.

The Data Cable COM UI Manager 328 allows the Remote Tester to manually enter textual information, or transfer other types of data or application files to the Data Cable of the Mobile Device. This is done by the Remote Tester manually entering information into any type of text entry control available in standard graphical user interface packages. The manually entered information will be transferred over the Data Cable of the Mobile Device. The Device Conductor also allows the Remote Tester to select one or more files to transfer to the Mobile Device.

The Data Cable COM API 330 supports a method for the Remote Automation Script to enter textual information, or transfer other types of data or application files to the Data Cable of the Mobile Device. Data can be sent immediately, or in a delayed manner by first defining an instruction for sending information over the Data Cable, and then causing a process to initiate at a later time which will execute the instruction and will send the information in a sequence as if they were being sent by the Remote Tester.

The Device Conductor COM Encoder 332 is responsible for converting this information to a format that can be transmitted over the Internet. The general configuration for this decoder is to compress the raw data using compression formats such as ZIP or other standard loss-less compression formats to reduce the amount of information being transferred over the internet. It is also valid to not encode this COM data at all, although this is less desirable due to the amount of network bandwidth that may be needed to transfer the COM information.

With regard to the Hardware Control UI Manager 334, the Device Conductor user interface allows a user to perform many tasks with the remote Mobile Device that may be done if the device were physically available. For example, connecting or disconnecting the wall charger, or inserting or removing the battery from the device, flipping a phone open or closed, and connecting or disconnecting the data cable from a device. Although these actions are similar to physical actions that would be taken, they are actually controlling a set of electro-mechanical switches which have been wired to perform the various connection and disconnection actions.

The Device Conductor allows the Remote Tester to connect and disconnect a local representation of the wall adapter power of the Mobile Device, which causes the wall adapter power to be connected or disconnected as if done by a person at that remote location. The wall adapter power can be connected or disconnected by interacting with a visual representation of the adapter using a pointing device such as a mouse, touch pad, or touch sensitive display. The visual representation of the wall adapter may be a graphical image of the adapter, a pre-defined visual button, a drop down menu item, or any other common form of input selection provided by standard graphical user interfaces. The wall adapter power can be connected or disconnected by pressing on a representative key of the computer keyboard. The representative key of the computer keyboard may be mapped from any key on the keyboard that is convenient for the Remote Tester.

The Device Conductor allows the Remote Tester to connect or disconnect a local representation of the battery power of the Mobile Device, which causes the battery power to be connected or disconnected as if done by a person at that remote location. The battery power can be connected or disconnected by interacting with a visual representation of the battery using a pointing device such as a mouse, touch pad, or touch sensitive display. The visual representation of the battery may be a graphical image of the battery, a pre-defined visual button, a drop down menu item, or any other common form of input selection provided by standard graphical user interfaces. The battery power can be connected or disconnected by pressing on a representative key of the computer keyboard. The representative key of the computer keyboard may be mapped from any key on the keyboard that is convenient for the Remote Tester.

The Device Conductor allows the Remote Tester to open or close a local representation of the flip-cover of the Mobile Device, which causes the flip-cover to be open or closed as if done by a person at that remote location. The flip-cover can be opened or closed by interacting with a visual representation of the flip-cover using a pointing device such as a mouse, touch pad, or touch sensitive display. The visual representation of the flip-cover may be a graphical image of the flip-cover, a pre-defined visual button, a drop down menu item, or any other common form of input selection provided by standard graphical user interfaces. The flip-cover can be opened or closed by pressing on a representative key of the computer keyboard. The representative key of the computer keyboard may be mapped from any key on the keyboard that is convenient for the Remote Tester.

The Device Conductor allows the Remote Tester to connect or disconnect a local representation of the data cable of the Mobile Device, which causes the data cable to be connected or disconnected as if done by a person at that remote location. The data cable can be connected or disconnected by interacting with a visual representation of the data cable using a pointing device such as a mouse, touch pad, or touch sensitive display. The visual representation of the data cable may be a graphical image of the data cable, a pre-defined visual button, a drop down menu item, or any other common form of input selection provided by standard graphical user interfaces. The data cable can be connected or disconnected by pressing on a representative key of the computer keyboard. The representative key of the computer keyboard may be mapped from any key on the keyboard that is convenient for the Remote Tester.

The Hardware Control API 336 supports a method for the Remote Automation Script to perform the same hardware control tasks that can be done through the user interface. Hardware connection/disconnection commands can be sent immediately, or in a delayed manner by first defining an instruction for performing the hardware control, and then causing a process to initiate at a later time which will execute the instruction and will send the information in a sequence as if they were being sent by the Remote Tester.

The Device Conductor Hardware Control Translation 338 is necessary to map the requested hardware control functionality to a set of switches that perform the specified task. Since Mobile Devices come in many physical configurations, this mapping is necessary to conform to the specific requirements of each device. For example, some Mobile Devices use 4 wires to connect their batteries to the physical handset. In this case, 4 electro-mechanical switches would be used to connect or disconnect the battery to the device. This translation mapping would specify which switches are used for the various functions available.

The Video Display UI Manager 340 allows for viewing a representation of the image that would appear on the LCD display of the remote Mobile Device. This LCD image data is converted into a standard image format by the Device Server and transferred over the Internet to the local desktop computer display. The most typical configuration of a mobile display is using LCD technology, but the information could also be viewed using other types of display technology such as Plasma, OLED (Organic LED), CRT or any number of other display technologies that can represent a digital image.

The Device Conductor allows the Remote Tester to view a local representation of video data from the LCD display of the remote Mobile Device in a manner equivalent to how video data of the LCD display would be understood by a person at the remote location. Video data on the local display may be rendered in the same pixel dimension as the LCD display of the remote Mobile Device. Video data on the local display may be rendered in a larger or smaller pixel dimension than the original LCD display by using any one of a variety of standard techniques for scaling graphical computer images.

Video data on the local display may be rendered using a one-to-one mapping of the original red, green and blue color values from the LCD display of the remote Mobile Device, where each original color value is mapped to a color value that represents the visible representation of the color on the local display. This may be done in conjunction with other video transformations. Video data on the local display may be rendered using a transformation of the red, green and blue color values in order to display the LCD video data using greater or fewer number of color values than were displayed on the original LCD video display. This may be done in conjunction with other video transformations. Video data on the local display may be rendered using a transformation of the red, green and blue color values in order to display the LCD video data so as to appear brighter or darker than the original LCD video display. This may be done in conjunction with other video transformations.

Video data on the local display may be rendered in its entirety displaying all of the pixel data that is displayed on the original LCD video display. This may be done in conjunction with other video transformations. Video data on the local display may be clipped so that only a sub-set of the video data displayed on the original LCD video display is displayed. The clipping could be of the outer edges of the video image, or by excluding sub-regions within the image. This may be done in conjunction with other video transformations.

Video data on the local display may be rendered in a loss-less manner such that none of the original color information available from the LCD video display is discarded before rendering on the local display. This may be done in conjunction with other video transformations. Video data on the local display may be rendered in a lossy manner such that some of the original color information available from the LCD video display is discarded as part of a process of data compression used to reduce the amount of data transmitted between the remote Mobile Device and the Device Conductor. This may be done in conjunction with other video transformations.

Video data on the local display may be rendered at an equivalent frame rate as the frame rate of the video being displayed on the LCD display of the remote Mobile Device. This may be done in conjunction with other video transformations. Video data on the local display may be rendered at a frame rate faster or slower than the frame rate of the video being displayed on the LCD display of the remote Mobile Device. This may be done in conjunction with other video transformations. Video data on the local display may consist of video from the LCD video display of the Mobile Device, mixed with additional video, animated or still image data. The visual data may be mixed with the original LCD video data to present additional information about the device, its operational status, or its environment. The visual data may be mixed with the original LCD video data to provide branding information such as a company name, product name, device name, company logo, or slogan. This may be done in conjunction with other video transformations.

The Video Comparison API 342 supports a method for the Remote Automation Script to store a previously recorded image captured from the LCD display and compare that stored image with the image data currently available on the remote Mobile Device. This image comparison is generally used to support automated testing of the Mobile Device or Mobile Application by waiting for one or more expected results from an action performed on the Mobile Device.

The Video Decompression Decoder 344 is used to decode the stream of video information as it is sent over the Internet. The video information is sent in a compressed format in order to minimize the amount of data being transferred. The actual video format being decoded is generally not important, and any number of standard or proprietary formats can be used. The most common configuration of this video decompression is to use a MPEG video format. Any image or video format, either loss-less or lossy, which conveys the meaning of the video display as it would be understood by a person viewing the display of the remote Mobile Device can be used.

With regard to the Audio Playback UI Manager 346, the Device Conductor allows the Remote Tester to hear a local representation of audio data from the speakers, ringer, or headset earpiece of the remote Mobile Device in a manner equivalent to how audio data would be understood by a person at the remote location.

Audio data on the local computer may be played at the same volume as the audio data would be heard by a person at the remote location. This may be done in conjunction with other audio transformations. Audio data on the local computer may be played at a louder or softer volume than the original audio would be heard by a person at the remote location. This may be done in conjunction with other audio transformations. Audio data on the local computer may be played in stereo format if the original. audio data on the remote Mobile Device is available in stereo format. This may be done in conjunction with other audio transformations.

Audio data on the local computer may be played in mono format if the original audio data on the remote Mobile Device is available in either mono or stereo format. This may be done in conjunction with other audio transformations. Audio data from the remote Mobile Device can be played on the local computer through the computer speakers, connected headset, or any other commonly used method of playing sound on a computer. This may be done in conjunction with other audio transformations. Audio data on the local computer may be played at an equivalent audio sampling rate as the original audio playback rate of the remote Mobile Device speakers, ringer, or headset. This may be done in conjunction with other audio transformations.

Audio data on the local computer may be played at a faster or slower sampling rate than the original audio playback rate of the remote Mobile Device speakers, ringer, or headset. This may be done in conjunction with other audio transformations. Audio data on the local computer may be played in a loss-less manner such that none of the original audio information available from the Mobile Device is discarded before playing on the local speaker or headset. This may be done in conjunction with other audio transformations. Audio data on the local computer may be played in a lossy manner such that some of the original audio information available from the Mobile Device is discarded as part of a process of data compression used to reduce the amount of data transmitted between the remote Mobile Device and the Device Conductor. This may be done in conjunction with other audio transformations.

The Audio Comparison API 348 supports a method for the Remote Automation Script to store a previously recorded audio sampled captured from the Mobile Device and compare that stored sample with the audio data currently available on the remote Mobile Device. This audio comparison is generally used to support automated testing of the Mobile Device or Mobile Application by waiting for one or more expected results from an action performed on the Mobile Device.

The Audio Decompression Decoder 350 is used to decode the stream of audio information as it is sent over the Internet. The audio information is sent in a compressed format in order to minimize the amount of data being transferred. The actual audio format being decoded is generally not important and any number of standard or proprietary formats can be used. The most common configuration of this video decompression is to use a MP3 audio format. Any audio format, either loss-less or lossy, which conveys the meaning of the audio as it would be understood by a person listening to the speaker of the remote Mobile Device can be used.

With regard to the Hardware Detect UI Manager 352, the Device Conductor allows the Remote Tester to hear or view a local representation of vibration of the remote Mobile Device in a manner equivalent to how vibration would be understood by a person at the remote location. Vibration information on the local computer may be rendered as a low frequency audio tone indicating the Mobile Device is vibrating. Vibration information on the local computer may be rendered as a visual shaking of the video image indicating the Mobile Device is vibrating. Vibration information on the local computer may be rendered as a static, or animated graphic icon indicating the Mobile Device is vibrating.

The Device Conductor allows the Remote Tester view a local representation of the intensity of the LCD backlight of the remote Mobile Device in a manner equivalent to how backlight intensity would be understood by a person at the remote location. Backlight intensity information on the local computer may be rendered as an increase or decrease in brightness of the current video image indicating the Mobile Device has increased or decreased the brightness of its LCD display. Backlight intensity information on the local computer may be rendered as a static, or animated graphic icon indicating the Mobile Device has increased or decreased the brightness of its LCD display.

The Device Conductor allows the Remote Tester to view a local representation of the power on or off status of the remote Mobile Device in a manner equivalent to how the power on or off status would be understood by a person at the remote location. Power on or off status on the local computer may be rendered as an increase or decrease in brightness of the current video image indicating the Mobile Device currently has, or does not have power. Power on or off status on the local computer may be rendered as a clearing of the video image with a black or gray or other static pattern, indicating the device is powered off. Power on or off status information on the local computer may be rendered as a static, or animated graphic icon indicating the Mobile Device is powered on or off.

The Hardware Detect API 354 supports a method for the Remote Automation Script to wait for a particular hardware action to occur. This audio comparison is generally used to support automated testing of the Mobile Device or Mobile Application by waiting for one or more expected results from an action performed on the Mobile Device.

The Hardware Detect Translation 356 is used to map the results from a particular sensor to the specific action that was detected on the hardware.

With regard to the Data Cable COM Output UI Manager 358, the Device Conductor allows the Remote Tester view a local representation of the debug messages available from the serial port of the remote Mobile Device in a manner equivalent to how the debug messages would be viewed by a person at the remote location. Debug messages from the Mobile Device are rendered as text messages on the local computer as they become available over the data port of the remote Mobile Device.

The Data Cable COM Comparison API 360 supports a method for the Remote Automation Script to wait for a particular stream of data to appear over the COM port connected to the remote Mobile Device. This COM data comparison is generally used to support automated testing of the Mobile Device or Mobile Application by waiting for one or more expected results from an action performed on the Mobile Device.

The Device Conductor COM Decoder 362 is responsible for converting the information received over the Internet to a format that can be viewed, or used in automated comparisons. The general configuration for this decoder is to uncompress the raw data using decompression formats such as ZIP or other standard loss-less decompression formats.

The Network Output Manager 364 is responsible-for translating commands and other data into a format that can be sent over local area networks, or over the Internet. The system converts the information into a standard network format, and then sends the data using standard operating system APIs for network communications which are found on most modern computer systems. The actual format used to transfer the data is generally not important as long as it can be decoded into the same set of information by the system receiving the data at another point in the network. The most common configuration of this data is to convert it into XML format, but other formats such as serialized objects are also common.

The Network Input Manager 366 is responsible for translating raw data being received from a local area network or the Internet into more meaningful commands or structured data that are routed to other parts of the system based on the type of information received. The system receives the data using standard operating system APIs for network communications which are found on most modem computer systems. The actual format used to transfer the data is generally not important as long as it can be encoded into the same set of information by the system sending the data at another point in the network. The most common configuration of this data is to convert it from XML format, but other formats such as serialized objects are also common.

### Device Server

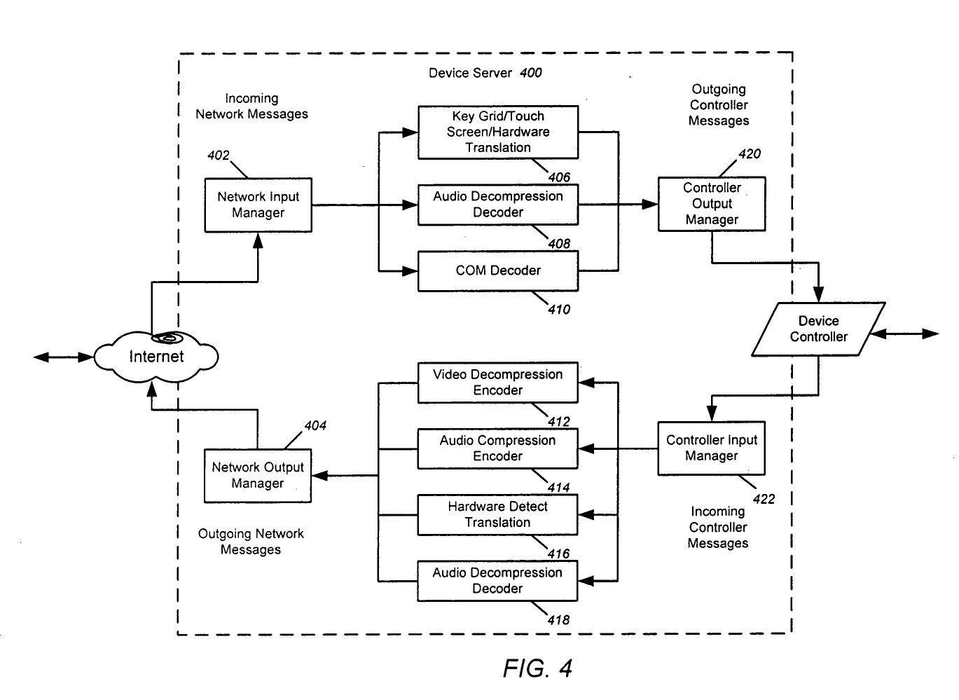

FIG. 4 is a block diagram of an exemplary Device Server 400 according to some embodiments of this invention. The Device Server 400 may be a software application that runs on the general purpose computer or server located near one or more Mobile Devices. The primary role of the Device Server 400 is to translate incoming network protocol messages into lower level data formats appropriate for controlling the Mobile Device. The most common configuration of the Device Server 400 is as a software application running on a general purpose computer, but this could also be implemented as a software application running on a standard or proprietary real time operating system running in an embedded microprocessor.

The most common configuration is for the Device Server 400 and the Device Controller to be physically separated systems and communicating over some type of data cable such as USB, or Firewire communication channel. The same functionality could also be achieved with the Device Server and the Device Controller running on the same server and communicating through shared memory, or through another standard bus interface such as a PCI data bus.

Network Input Manager 402 is responsible for translating raw data being received from a local area network or the Internet into more meaningful commands or structured data that are routed to other parts of the system based on the type of information received. The system receives the data using standard operating system APIs for network communications which are found on most modern computer systems. The actual format used to transfer the data is generally not important as long as it can be encoded into the same set of information by the system sending the data at another point in the network. The most common configuration of this data is to convert it from XML format, but other formats such as serialized objects are also common.

The Network Output Manager 404 is responsible for translating commands and other data into a format that can be sent over local area networks, or over the Internet. The system converts the information into a standard network format, and then sends the data using standard operating system APIs for network communications which are found on most modern computer systems. The actual format used to transfer the data is generally not important as long as it can be decoded into the same set of information by the system receiving the data at another point in the network. The most common configuration of this data is to convert it into XML format, but other formats such as serialized objects are also common.

The Key Grid/Touch Screen/Hardware Translation process 406 is responsible for converting the incoming keypad, touch screen, or hardware electro-mechanical switch commands into a lower level format that includes a complete set of timing information for connecting and disconnecting the appropriate switches in the correct pattern to enable the desired functionality. For example, to press a particular key on a Mobile Device may require that several physical contacts are made at the same time. It may also require that these physical contacts are held for a minimum amount of time (usually around 200 ms) and then released. This translation process is responsible for defining the full event sequence to perform the hardware functionality.

The Audio Decompression Decoder 408 is used to decode the stream of audio information as it is sent over the Internet. The audio information is sent in a compressed format in order to minimize the amount of data being transferred. The actual audio format being decoded is generally not important and any number of standard or proprietary formats can be used. The most common configuration of this video decompression is to use a MP3 audio format. Any audio format, either loss-less or lossy, which conveys the meaning of the audio as it would be understood by a person speaking into the microphone of the remote Mobile Device can be used.

The Device Server COM Decoder 410 is responsible for converting the information received over the Internet to a format that can be sent directly to the data cable of the Mobile Device. The general configuration for this decoder is to uncompress the raw data using standard compression formats such as ZIP or other standard loss-less compression formats to reduce the amount of information being transferred over the internet. It is also valid to not encode this COM data at all, although this is less desirable due to the amount of network bandwidth that may be needed to transfer the COM information.

The Video Compression Encoder 412 is used to encode the stream of video information as it is sent over the Internet. The video information is sent in a compressed format in order to minimize the amount of data being transferred. The actual video format being used for the encoding is generally not important and any number of standard or proprietary formats can be used. The most common configuration of this video decompression is to use a MPEG video format. Any image or video format, either loss-less or lossy, which conveys the meaning of the video display as it would be understood by a person viewing the display of the remote Mobile Device can be used.

The Audio Compression Encoder 414 will encode and compress the audio data into a lower bandwidth format which represents as closely as possible the original audio information that was detected from the Mobile Device. The most common method of encoding the audio is to filter out any audio below a particular noise threshold since that audio may not be audible by the Remote Tester. After filtering the low volume audio information, an encoder suitable for both music and voice, such as an MP3 encoded audio format is used to reduce the size of the audio information to be transferred.

The actual method and format of encoding the audio data is generally not important as long as the audio information can be reconstructed later to represent something that would be perceived as similar to the original audio information. Several standard and proprietary encoding formats will work equally well for reducing the amount of audio information that is to be sent over the Internet. It is also equally valid to transfer the audio data in an uncompressed format, but this is less desirable due to the amount of network bandwidth consumed by this information.

The Device Server Hardware Detect Translation block 416 is necessary to map the requested hardware control functionality to a set of switches that perform the specified task. Since Mobile Devices come in many physical configurations, this mapping is necessary to conform to the specific requirements of each device. For example, some Mobile Devices use 4 wires to connect their batteries to the physical handset. In this case, 4 electro-mechanical switches would be used to connect or disconnect the battery connection for the device. This translation mapping would specify which switches are used for the various functions available.

The Device Server COM Encoder 418 is responsible for converting the information to be transferred over the Mobile Device Data Cable into a format that is suitable for transfer over the Internet. The general configuration for this encoder is to simply compress the raw data using standard compression formats such as ZIP or other standard loss-less compression formats to reduce the amount of information being transferred over the internet. It is also valid to not encode this COM data at all, although this is less desirable due to the amount of network bandwidth that may be needed to transfer the COM information.

The Controller Output Manager process 420 is responsible for translating commands and other data into a format that can be sent over local data cable to be handled by the Device Controller. The system converts the information into a standard network format, and then sends the data using standard operating system APIs for USB or other data cable communications which are found on most modem computer systems. The actual format used to transfer the data is generally not important as long as it can be decoded into the same set of information by the process receiving the data at the other end of the data cable connection. The most common configuration of this data is to convert it into XML format, but a simple file or memory data structure is also common.

The Controller Input Manager 422 is responsible for translating raw data being received from a local data cable into more meaningful commands or structured data that are routed to other parts of the system based on the type of information received. The system receives the data using standard operating system APIs for USB or other data cable communications which are found on most modem computer systems. The actual format used to transfer the data is generally not important as long as it can be decoded into the same set of information by the process receiving the data at the other end of the data cable connection. The most common configuration of this data is to convert it into XML format, but a simple file or memory data structure is also common.

### Device Controller

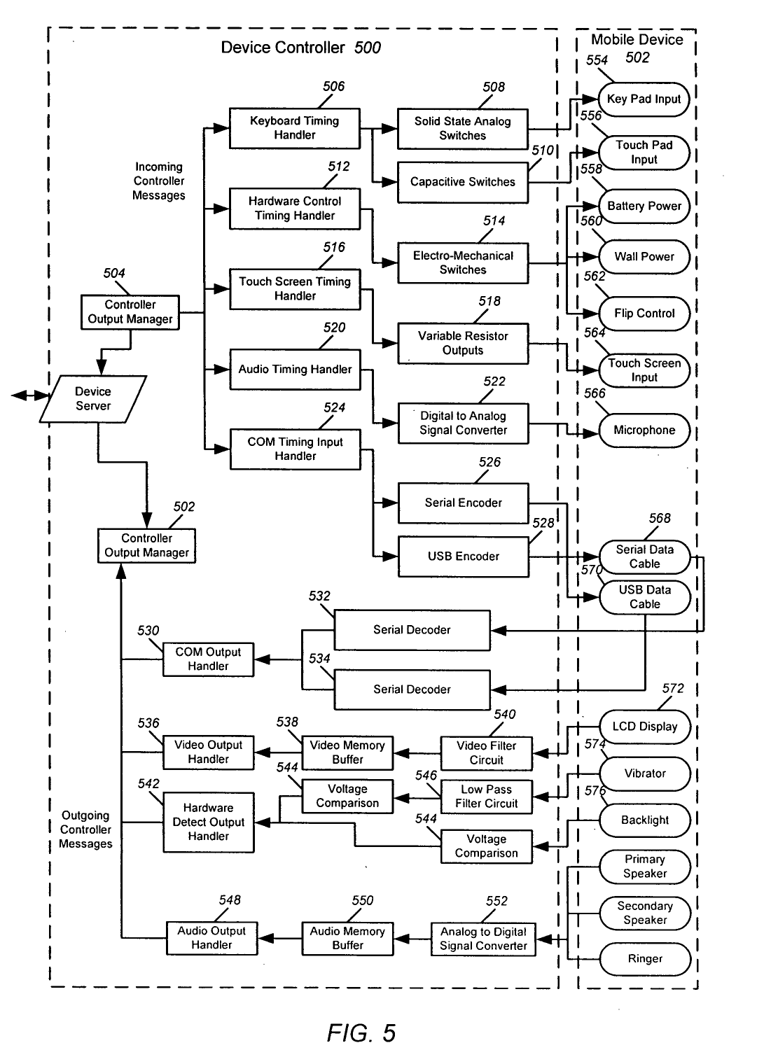

FIG. 5 is a block diagram of an exemplary Device Controller 500 and Mobile Device 502 according to some embodiments of this invention. The most common configuration for the Device Controller 500 is hardware integration with a physical Mobile Device 502. This is achieved by directly connecting wires to the electrical input and output points of the Mobile Devices, and simulating physical interaction with the device by generating electrical impulses that are similar to those that would be generated during physical interaction with the device. For example, pressing a key on a Mobile Device keypad will generally make an electrical contact between two exposed contact surfaces on the circuit board of a Mobile Device. The hardware integration with replace this physical contact circuit with a solid state switch such as a MOSFET, or with an electro-mechanical switch that uses magnetism to cause a circuit contact to be made.

It will also intercept electrical signals generated by the device that would be intended to give visual, aural, or tactile feedback to a person located near the device. This is generally done by placing electrical sensors at various points on the device to detect the current electrical voltage levels at that point. This approach is commonly used with off the shelf equipment such as a logic analyzer, or oscilloscope.

Alternately, the Device Controller may simulate the same type of physical interaction with the device by interacting with the Mobile Device operating system, and not creating direct electrical connections with the device. In this configuration, a software agent running on the Mobile Device will communicate with the operating system of the Mobile Device in order to simulate user interaction with the device. Note that in the case where the Device Controller is a software platform, it will generally execute its code within the software operating system of the Mobile Device, and will communicate with the operating system of the Mobile Device in order to retrieve information that would be intended to give visual, aural, or tactile feedback to a person located near the device.

If the Device Controller is a software agent, it will communicate with the Device Server over the same type of data cable, such as a USB, or Firewire data cable. In this case, it may also communicate using a wireless protocol such as Bluetooth, CDMA, or GPRS, or any number of emerging WiFi or 3G wireless protocols that are commonly supported by Mobile Devices.

The Controller Output Manager process 502 is responsible for translating commands and other data into a format that can be sent over local data cable to be handled by the Device Controller. The system converts the information into a standard network format, and then sends the data using standard operating system APIs for USB or other data cable communications which are found on most modem computer systems. The actual format used to transfer the data is generally not important as long as it can be decoded into the same set of information by the process receiving the data at the other end of the data cable connection. The most common configuration of this data is to convert it into XML format, but a simple file or memory data structure is also common.

The Controller Input Manager 504 is responsible for translating raw data being received from a local data cable into more meaningful commands or structured data that are routed to other parts of the system based on the type of information received. The system receives the data using standard operating system APIs for USB or other data cable communications which are found on most modem computer systems. The actual format used to transfer the data is generally not important as long as it can be decoded into the same set of information by the process receiving the data at the other end of the data cable connection. The most common configuration of this data is to convert it into XML format, but a simple file or memory data structure is also common.

The Keyboard Timing Handler 506 is responsible for converting the sequence of keyboard or touch pad (mobile key pads that use touch sensitive capacitive inputs) keys into timed events. This is necessary since each individual key press is comprised of multiple physical switch closures that require precise timing to execute.

Each individual electrical connection necessary for key pad input is controlled by a solid state analog switch 508. This most common type of configuration for this is a MOSFET switch, but various types of analog switches can be used. Also, electro-mechanical switches can be used for this, but are less desirable since they result in higher impedance introduced into the Mobile Device circuit.

Each individual connection necessary for a touch pad input is controlled by a solid state capacitive switch 510. This type of switch emulates the capacitance of a human finger when applied to a touch sensitive key pad button.

The Hardware Control Timing Handler 512 is responsible for converting the sequence of hardware control requests (battery, wall power, flip control) into timed events. This is necessary since each individual hardware control requests is comprised of multiple physical switch closures that require precise timing to execute.

Each individual electrical connection necessary for key pad input is controlled by a solid state analog switch. This most common type of configuration for this is an electro-mechanical switch 514, but various types of solid-state switches such as MOSFETS can be used.

The Touch Screen Timing Handler 516 is responsible for converting the sequence of touch screen requests (X, Y coordinate location values) into timed events. This is necessary since each touch screen requests is comprised of multiple resistance value settings and a physical switch closure that requires precise timing to execute.

The touch screen control is handled by a set of variable resistors 518 that can be used to simulate the precise location that a person might select on the touch panel screen. The variable resistors are set to particular values that are interpreted as X and Y position locations by the Mobile Device.

The Audio Timing Handler 520 is responsible for converting the sequence of digital audio samples into a precisely timed sequence of analog waveforms that can be interpreted by microphone input circuitry as audio information. The most common configuration for this timing is to convert 16,000 digital samples each second into a corresponding analog audio waveform. A smaller or larger number of samples could also be used and they would correspond generally to lower or higher quality audio waveforms being produced.

A digital to analog signal converter circuit 522 will simply convert a digital value (for example a value ranging from −32768 to +32767) into a corresponding analog positive or negative voltage level. A series of these conversions can be combined to create audio waveforms that when amplified and played through a speaker, would be understood as sound by a human ear.

The COM Timing Input Handler 524 is responsible for taking the incoming data cable communication data and sending it to the Mobile Device at the correct data rate. This is necessary to perform the correct timings needed for serial or USB communication.

The Serial Encoder process 526 converts raw data into a serial format stream that can be transferred over a serial data cable. This is generally an 8-bit parallel to low speed serial conversion.

The USB Encoder process 528 converts raw data into a format stream that can be transferred over a USB data cable. This is generally an 8-bit parallel to high speed serial conversion.

The COM Output Handler 530 is responsible for taking the incoming data cable communication data and converting it into a format that is suitable for communication to the Device Server. The format of the data is generally a simple uncompressed stream of 8 bit data values that represent the information being transferred over the data cable.

The Serial Decoder 532 converts the information being transferred over a serial data cable into a raw data stream of information. This is generally a low speed serial to 8-bit parallel conversion.

The USB Encoder 534 converts the information being transferred over a USB data cable into a raw data stream of information. This is generally an high speed serial to 8-bit parallel conversion.

The Video Output Handler 536 converts the video memory buffer into a standard format that can be transferred to the Device Server. The standard video format is generally a 24-bit RGB format with one pixel representing each location visible on the LCD display of the Mobile Device. The video data is also generally converted into equal sized packets for more efficient transfer to the Device Server. The detailed conversion process used to convert the incoming information into a standard format is out of the scope of this document, and is described elsewhere.

The Video Memory Buffer 538 will store video information as it comes in from the device while the data is waiting to be transferred to the Device Server. The most common video memory buffer is a large SRAM chip, but other types of solid-state memory, or magnetic disk drives could be used to temporarily store the information. This temporary storage is commonly referred to as bus matching in order to buffer high speed data being transferred from one data bus to a second data bus of unequal speed or size.

The Video Filter Circuit 540 is responsible for filtering out information that is extracted from the LCD communication stream of the Mobile Device, but is not actually important for re-creating an image of the Mobile Device at a later time. This filtering is necessary because it is common for a Mobile Device to communicate to more than one circuit over the same data bus, and selection data lines are used to indicate which circuit is intended to receive the current information being transferred.

The Hardware Detect Output Handler 542 converts the voltage comparison output from the expected state of the particular voltage being detected to determine if the detected signal is active or not. Generally this will invert the status of the detection circuitry if necessary for a particular Mobile Device. This step is important because different Mobile Devices will use different activation voltages to enable or disable the backlight or vibration control for the device. Some devices will use a low voltage of 0 Volts to enable a device, others will use a high voltage of 1.8 Volts or higher to enable a device.

The Voltage Comparison process 544 will compare a detected circuit voltage with a pre-set voltage threshold value in order to determine if the detected voltage is above or below the voltage threshold. If the detected voltage is above the threshold, this circuit will active a binary data line. If the detected voltage is below the threshold, it will disable the binary data line.

The Low Pass Filter Circuit 546 will filter out quickly changing signal values and convert them into a signal value that is changing much more slowly. This step is necessary for the detection of vibration control activation since this activation is often done with a quickly oscillating digital signal. The low pass filter will convert this into a simple binary activation detection.

This audio output handler 548 converts the audio stream of information into a more standard format to be transferred to the Device Server. The audio data is generally converted into equal sized packets for more efficient transfer to the Device Server.

The Audio Memory Buffer 550 will store audio information as it comes in from the device while the data is waiting to be transferred to the Device Server. The most common audio memory buffer is a small SRAM chip, but other types of solid-state memory, or magnetic disk drives could be used to temporarily store the information. This temporary storage is commonly referred to as bus matching in order to buffer high speed data being transferred from one data bus to a second data bus of unequal speed or size.

An-analog to digital signal converter circuit 552 will simply convert an analog voltage value (for example, a voltage level between −5 Volts and +5 Volts) into a digital representation of the voltage (for example, a value ranging from −32768 to +32767). These digital values can be transferred easily by standard computer systems and can be later re-formed into something equivalent to the original analog signal.

Key Pad Input 544 is a key pad input on a Mobile Device. Typically this is a numerical key pad, and several navigation or other special function keys that control the functionality of the Mobile Device. This can range from 15 to 60 or more keys depending on the functionality of the Mobile Device.

Touch Pad Input 556 is a variation of a key pad input that uses a touch sensitive panel to represent one or more keys. This is an alternate input method that is becoming more commonly used by Mobile Devices.

The Battery Power block 558 represents the battery that is connected to the Mobile Device to provide power for the device. The physical connections for the battery are interrupted and replaced by a switch to allow the battery connection to be controlled.

Wall Power block 560 represents the wall power adapter connection that is used to charge the battery for a Mobile Device. The wires coming from the adapter are interrupted and replaced by a switch to allow the wall power connection to be controlled.

The flip control 562 is an electrical switch that can be controlled on a Mobile Device to simulate opening or closing of a flip style phone. This switch is either a physical switch, or is controlled by a magnetic sensor. In either case, the control lines are intercepted and replaced by a switch to allow the phone flip state to be controlled.

Touch Screen Input 564 is a touch screen input pad on a Mobile Device. Typically this is a touch sensitive panel which is placed over the main display of the Mobile Device. There are various types of touch sensitive displays, but the most common form uses resistance measurements to identify an X, Y location where a person has touched the screen. This touch sensitive panel is removed and replaced with a set of variable resistors which can simulate the values read by the panel sensor in order to act as if the panel as been pressed at a specific location.

Microphone 566 is the microphone of the Mobile Device. The physical microphone is removed and is replaced by wires from the output of a digital to analog conversion circuit which can generate audio waveforms from incoming digital data.

Serial Data Cable 568 block represents a serial data cable connection that is available on some Mobile Devices. This cable is used to communicate with the device for transferring files or other debugging information to and from the device. The incoming serial signal is routed to a Serial Encoder, and the outgoing serial signal is routed from a Serial Decoder. This allows the Device Controller to intercept the external serial communication with the Mobile Device and route that communication to the Remote Tester.

USB Data Cable block 570 represents a USB data cable connection that is available on some Mobile Devices. This cable is used to communicate with the device for transferring files or other debugging information to and from the device. The incoming USB signal is routed to a USB Encoder, and the outgoing USB signal is routed from a USB Decoder. This allows the Device Controller to intercept the external USB communication with the Mobile Device and route that communication to the Remote Tester.

LCD Display 572 is the LCD display of the Mobile Device which is used to display the current status information about the device and to interact with Mobile Applications running on the device. The communication to the LCD display is intercepted so the display information can be transferred to the Device Server. In order to extraction information from the Mobile Display, sensors are placed on the digital communication lines between the CPU of the Mobile Device and its display. The process to decode this information and convert this into a standard image format is out of scope of this document, and is described elsewhere.

Vibrator 574 is the vibrator of the Mobile Device. The vibrator is generally a simple spinning motor that provides some tactile feedback from the device when a call is being received, or some other application event occurs. The vibrator is generally removed and sensors are placed on the signal wires that would have turned on the vibration feedback controls.

Backlight block 576 is the backlight display that is used to control the brightness of the LCD display. Sensors are placed on the backlight wires running to the display and are used to detect when the display backlight is enabled.

The Primary/Secondary/Ringer Speaker block 578 represents speakers that are used to play audio information from the device. The most common configuration of a mobile device is to have a single primary speaker, but some devices have multiple speakers for speakerphone functionality, and for stereo sound. The speakers are removed from the device and wires are run to an analog to digital signal converter to transform the audio information into digital data that can be transferred to the Remote Tester. If multiple speakers are present, the signals are first combined with a simple resistor/capacitor circuit to provide a single input audio signal.

The Mobile Device 502 is produced by third party device manufacturers and are generally a hand held battery operated device with a small visual LCD screen used to convey information or interact with software applications running on the device. Mobile Devices include wireless phones, wireless PDA's, and other devices that require a Carrier Network to be fully operational.

Mobile Devices have the ability to run software applications produced by the device manufactures, or by third party developers. Software applications can be loaded onto the Mobile Device by connecting the device to a computer with a data cable attached between the device and the computer. Software applications can also be loaded over the air using standard communication protocols to download the application from computers hosted by the Carrier Network. Mobile Applications include, but are not limited to, mobile games, productivity applications, location based applications, and mobile web sites.

Carrier Networks are run by third party operators and provide transmission of voice or data information to and from Mobile Devices. The voice and data information is transferred to and from the device using standard wireless protocols. The wireless protocols include, but are not limited to GSM, GPRS, CDMA, WCDMA, EDGE and other 3G wireless protocols. The Carrier Network itself is outside the scope of the remote access to the Mobile Device invention, but is important because the Mobile Device must reside in the Carrier Network, and this is the primary reason why the device needs to be controlled remotely.

### Component Interactions

The Remote Tester is generally a person that is interacting with the Device Conductor as a software application running on a computer physically located near the person. The interaction with the software application can be done directly without the assistance of any other standard application. The interaction with the software application can also be done with the assistance of another standard application such as a web browser, or the graphical interface of a virtual machine, such as Java, C#, Visual Basic or any other similar virtual machine.

The Remote Tester interacts with the application using standard computer input devices such as a computer keyboard, a pointing device such as a mouse or touch pad, or touch sensitive display. The Remote Tester could also be an automation program used to control the Device Conductor without human interaction. In this case, the Remote Tester utilizes input device emulation support to simulate user input from standard computer input devices. This includes simulated input from devices such as a computer keyboard, a pointing device such as a mouse or touch pad, or touch sensitive display. This simulation is done in such a way as to make the interaction with the application similar to interaction that would be done by a person directly interacting with the application.

The Device Conductor application is run on a general-purpose computing device that is connected to a local area, or wide area network. This network is in some way connected to the Internet, which allows communication to another general-purpose computing device running the Device Server application. This remote computing device is connected to a network in the remote location that is also connected in some way to the Internet. The networks on either side of the connection could also include wireless networks such as Wi-Fi networks, or longer-range wireless networks such as those supported by Carrier Networks.

Although the most typical case of communication between the Device Conductor and the Device Server is through the Internet, the communication is also commonly run over a single local area, or wide area network. The actual distance and network topology between the Device Conductor and the Device Server is not significant, and there are many applications of the technology that benefit from remote control of Mobile Devices that are located physically close to the Remote Tester.

The low-level communication protocols over the network can include UDP or TCP/IP or other standard protocols used to send information between two computing devices connected over a network. The lower-level protocol encapsulates higher-level formatted information exchanged between the Device Conductor and the Device Server. This information can be encoded in any number of data exchange formats, including XML, HTTP, ASCII, or binary format.

The detailed format of the information is generally not significant as many distinct formats can be used to communicate similar information. The information transferred may be compressed to conserve data transfer bandwidth, or may be uncompressed to reduce the amount of processing for both the sender and receiver of the information. The information could also be encrypted to protect the content of the information being understood by third parties that may have access to the information.

The Device Server and the Device Controller are located physically close to each other and can use any number of short-range communication techniques to transfer commands and information. The communication between the components can be over a physical data cable or a wireless connection.

A data cable can transfer information using standard protocols such as Universal Serial Bus, Serial, Parallel, SCSI, SATA, Firewire, or any other standard, or custom data transfer protocol. A wireless connection can transfer information using standard wireless protocols such as Bluetooth, Wi-Fi, or any other standard or custom wireless data transfer protocol. The exact communication mechanism between the Device Server and the Device Controller is generally not significant as many distinct formats or protocols can be used to communicate similar information.

The Device Controller can either be based on a hardware platform used to simulate electrical input to the device, or a software platform used to communicate to the internal operating system of the Mobile Device. The Device Controller can also be based on a combination of both hardware and software using some aspects of each platform to communicate with the Mobile Device. In the case where the Device Controller is a hardware platform, the communication to and from the Mobile Device is accomplished by wires directly connected at various electrical input and output points of the device.

A Mobile Device typically accepts key press input by detecting electrical impulses at various positions on the device. The hardware Device Controller simulates this key press by connecting wires to these electrical contacts and providing an electrical impulse that the Mobile Device recognizes as a key press.

A Mobile Device typically accepts power button input by a voltage level connected to a location on the device. The hardware Device Controller simulates this power button by providing a voltage level at the correct location that the Mobile Device recognizes as its power button being pressed.

A Mobile Device typically accepts touch screen input by electrical sensors at various locations on a touch sensitive film. The hardware Device Controller simulates this touch screen input by connecting wires to these electrical contacts and providing the correct voltage or resistance level that the Mobile Device recognizes as its touch screen being pressed.

Mobile Device typically accepts audio input an analog voltage pattern generated by a microphone, or headset microphone. The hardware Device Controller simulates this audio by connecting wires to these analog electrical contacts and providing an analog voltage pattern that the Mobile Device recognizes as audio input similar to the audio generated by a person speaking, or a sound recording being played, into the microphone.

A Mobile Device typically accepts wall adapter power by a detecting voltage on a set of input lines and using that power too run the device and charge its battery. The hardware Device Controller simulates this wall adapter power by providing a similar voltage and amperage level to the Mobile Device that the device recognizes as its wall adapter.

A Mobile Device typically accepts battery input by connecting to multiple electrical leads on a battery compatible with the device. The hardware Device Controller uses electrically controlled switches to allow this battery power to be passed to the device, or be isolated from the device.

A Mobile Device typically accepts flip-cover input by detecting an electrical connection when a flip-cover is closed, or by detecting a magnetic field when a magnet in the flip-cover is close to a detector. The hardware Device Controller either provides a similar electrical connection voltage, or generates a magnetic field similar to the one available from the flip-cover magnet.

A Mobile Device typically accepts data cable input by connecting to multiple electrical leads on a data cable compatible with the device. The hardware Device Controller uses electrically controlled switches to allow this data cable connection to be passed to the device, or be isolated from the device.

A Mobile Device typically outputs LCD video data by communicating with an LCD display using a pattern of digital signals sent over a data bus to the display. The hardware Device Controller intercepts this communication and converts the information into a video image similar to the image that would appear on the display. The Device Controller may not process all of the video information, but may leave some of the processing to the Device Server.

A Mobile Device typically outputs audio speaker and ringer data by sending an analog voltage pattern to one or more speakers located inside the device, or to a speaker in a connected or wireless headset. The hardware Device Controller intercepts this analog voltage pattern and converts it to a similar digital pattern that is then transferred to the Device Server.

A Mobile Device typically outputs vibration information by sending an electrical voltage, or voltage pattern to a small motor inside the device. The hardware Device Controller detects this voltage pattern and communicates the presence of vibration to the Device Server.

A Mobile Device typically outputs LCD backlight or device power information by setting a voltage level on one or more wires connected to the LCD display. The hardware Device Controller detects this voltage level and communicates the presence of LCD backlight or device power to the Device Server.

In the case where the Device Controller is a software platform, the communication to and from the Mobile Device is accomplished by internal communication with the software operating system of the Mobile Device. The exact protocol used to communicate with the operating system of the Mobile Device is not significant. Many different methods can be used to communicate similar information to the device operating system.

All input to the Mobile Device is handled in a similar manner. The software Device Controller sends the input request to the software operating system of the Mobile Device. The operating system treats this request in a similar manner as it would treat the input if it came from an electrical sensor on the device.

All output from the Mobile Device is handled in a similar manner. The software Device Controller requests output information from the software operating system of the Mobile Device. The operating system sends this requested information to the Device Controller in a way that provides information similar to the information that would be displayed to a person operating the device.

Mobile Devices have the ability to run software applications produced by the device manufactures, or by third party developers. Software applications can be loaded onto the Mobile Device by loading the application over the air using wireless protocols supported by the Carrier Network.

Software applications running on the Mobile Device can also interact with the Carrier Network while the application is running. For example, the application can communicate with a central server to retrieve information, or messages, for the person using the software application.

This communication with the Carrier Network is outside the scope of the remote access to the Mobile Device invention, but is important because it is the primary reason why the Mobile Device must reside in the Carrier Network and thus needs to be controlled remotely.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A system for remotely testing a mobile device while the mobile device is located in a target carrier network, comprising:
a device server configured for
receiving network messages over a network and translating the messages into control information in a lower level format for controlling the mobile device, and
receiving operational information in the lower level format indicative of mobile device operation and translating the operational information into network messages for transmission over the network; and
a device controller couplable to the device server and the mobile device and configured for
receiving the control information from the device server and stimulating the mobile device with the control information, and
receiving the operational information from the mobile device and transmitting the operational information back to the device server.

2. The system of claim 1, the device controller further configured for stimulating the mobile device via direct electrical connections with the mobile device.

3. The system of claim 2, the device controller further configured for stimulating the mobile device via communications with an operating system of the mobile device.

4. A method for remotely testing a mobile device while the mobile device is located in a target carrier network, comprising:
receiving network messages over a network and translating the messages into control information in a lower level format for controlling the mobile device;
receiving operational information in the lower level format indicative of mobile device operation and translating the operational information into network messages for transmission over the network;
receiving the control information from the device server and stimulating the mobile device with the control information; and
receiving the operational information from the mobile device and transmitting the operational information back to the device server.

5. The method of claim 4, further comprising stimulating the mobile device via direct electrical connections with the mobile device.

6. The method of claim 4, further comprising stimulating the mobile device via communications with an operating system of the mobile device.

7. A computer-readable medium comprising program code for remotely testing a mobile device while the mobile device is located in a target carrier network, the program code for causing performance of a method comprising:
receiving network messages over a network and translating the messages into control information in a lower level format for controlling the mobile device;
receiving operational information in the lower level format indicative of mobile device operation and translating the operational information into network messages for transmission over the network;
receiving the control information from the device server and stimulating the mobile device with the control information; and
receiving the operational information from the mobile device and transmitting the operational information back to the device server.

8. The computer-readable medium of claim 7, the method further comprising stimulating the mobile device via direct electrical connections with the mobile device.

9. The computer-readable medium of claim 7, the method further comprising stimulating the mobile device via communications with an operating system of the mobile device.

10. A system for remotely testing a mobile device while the mobile device is located in a target carrier network, comprising:
means for receiving network messages over a network and translating the messages into control information in a lower level format for controlling the mobile device;
means for receiving operational information in the lower level format indicative of mobile device operation and translating the operational information into network messages for transmission over the network;
means for receiving the control information from the device server and stimulating the mobile device with the control information; and
means for receiving the operational information from the mobile device and transmitting the operational information back to the device server.

11. The system of claim 10, further comprising means for stimulating the mobile device via direct electrical connections with the mobile device.

12. The system of claim 10, further comprising means for stimulating the mobile device via communications with an operating system of the mobile device.

13. A system for remotely testing a mobile device while the mobile device is located in a target carrier network, comprising:
a device conductor configured for
converting actions from a remote tester into network messages for controlling the mobile device and transmitting the network messages over a network, receiving network messages indicative of mobile device operation from the network, and
providing a user interface for enabling the remote tester to enter actions and displaying mobile device operations in accordance with the received network messages.

14. The system of claim 13, the remote tester comprising a remote automation script, the device conductor further configured for converting actions from the remote automation script into network messages for controlling the mobile device.

15. A method for remotely testing a mobile device while the mobile device is located in a target carrier network, comprising:
converting actions from a remote tester into network messages for controlling the mobile device and transmitting the network messages over a network;
receiving network messages indicative of mobile device operation from the network; and
providing a user interface for enabling the remote tester to enter actions and displaying mobile device operations in accordance with the received network messages.

16. The method of claim 15, the remote tester comprising a remote automation script, the method further comprising converting actions from the remote automation script into network messages for controlling the mobile device.

17. A computer-readable medium comprising program code for remotely testing a mobile device while the mobile device is located in a target carrier network, the program code for causing performance of a method comprising:
converting actions from a remote tester into network messages for controlling the mobile device and transmitting the network messages over a network;
receiving network messages indicative of mobile device operation from the network; and
providing a user interface for enabling the remote tester to enter actions and displaying mobile device operations in accordance with the received network messages.

18. The computer-readable medium of claim 17, the remote tester comprising a remote automation script, the method further comprising converting actions from the remote automation script into network messages for controlling the mobile device.

19. A system for remotely testing a mobile device while the mobile device is located in a target carrier network, comprising:
means for converting actions from a remote tester into network messages for controlling the mobile device and transmitting the network messages over a network;
means for receiving network messages indicative of mobile device operation from the network; and
means for providing a user interface for enabling the remote tester to enter actions and displaying mobile device operations in accordance with the received network messages.

20. The system of claim 19, the remote tester comprising a remote automation script, the system further comprising means for converting actions from the remote automation script into network messages for controlling the mobile device.
